(19) United States
(12) Patent Application Publication
(10) Pub. No.: US 2007/0110841 A1
(43) Pub. Date: May 17, 2007

(54) Molding machine and molding method

(75) Inventors: Akihisa Kobayashi, Chiba (JP); Shinji Terada, Chiba (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 10/559,793

(22) PCT Filed: Jun. 10, 2004
(86) PCT No.: PCT/JP04/08102

§ 371 Date: Dec. 8, 2005

(30) Foreign Application Priority Data
Jun. 11, 2003 (JP) JP2003-166813

(51) Int. Cl. B29C 45/00

(52) U.S. Cl. 425/542

(57) ABSTRACT

The object is to provide a molding machine and a molding method which can decrease the load applied to a hydraulic pressure source and decrease energy consumption. It includes an actuator which is driven by supplied oil, an accumulator which is disposed along an oil passage for supplying oil to the actuator, a drive pressure sensing means which senses the drive pressure for driving the actuator, a charge pressure sensing section which senses the charge pressure of the accumulator, and a charge pressure setting processing means which sets the charge pressure on the basis of the charge pressure which was sensed and the drive pressure which was sensed. In this case, the charge pressure is set on the basis of the sensed charge pressure and the sensed drive pressure, so oil at an unnecessarily high charge pressure is not stored in the accumulator. Accordingly, the load applied to the hydraulic pressure source is decreased by this amount, and energy consumption can be decreased.

### TECHNICAL FIELD

The present invention relates to a molding machine and a molding method.

### BACKGROUND ART

Conventionally, in a molding machine, such as an injection molding machine, having a drive apparatus which is operated by a hydraulic circuit, a resin which is heated and melted within a heating cylinder is injected at high pressure to fill the cavity of a mold apparatus, and is cooled and solidified inside the cavity to form a molded article.

For this purpose, the above-described injection molding machine has a mold-clamping apparatus and an injection apparatus, and the mold-clamping apparatus has a stationary platen and a movable platen. Closing, clamping, and opening of the mold apparatus are carried out by driving a mold-clamping cylinder and advancing and retracting the movable platen.

The above-described injection apparatus has a heating cylinder which heats and melts resin which is supplied thereto from a hopper, and an injection nozzle which injects the molten resin. A screw is disposed inside the heating cylinder so as to be able to rotate and so as to be able to advance and retract. If an injection cylinder is driven and the screw is advanced, resin is injected from the injection nozzle and fills the cavity.

A hydraulic circuit is provided for driving actuators such as the mold-clamping cylinder and the injection cylinder. In this hydraulic circuit, oil discharged from a hydraulic pump (hydraulic pressure source) upon drive thereof is supplied to an oil chamber of an actuator. In cases where a large amount of oil must be supplied to the oil chamber in order to drive the actuator, the amount of oil which is discharged from the hydraulic pump is inadequate. Therefore, an accumulator is disposed in the hydraulic circuit. Oil at a prescribed pressure; i.e., at a charge pressure, is stored within the accumulator, and when the actuator is driven, oil stored within the accumulator is supplied to the oil chamber.

Therefore, the hydraulic circuit includes a charge pressure sensor which senses the charge pressure, a logic valve which assumes an on-load position and an unload position in accordance with the charge pressure sensed by the charge pressure sensor; i.e., the sensed charge pressure, an on-load switching valve for switching the logic valve, and other components. When the sensed charge pressure falls below a preset lower limit, the logic valve is switched by the on-load switching valve and placed in its on-load position, and oil discharged from the hydraulic pump is stored in the accumulator. When the sensed charge pressure exceeds a preset upper limit, the logic valve is switched by the on-load switching valve and placed in its unload position, and oil discharged from the hydraulic pump is drained (see Patent Document 1, for example).

Patent Document 1: Japanese Patent Application Laid-Open (kokai) NO. H5-92462

### DISCLOSURE OF THE INVENTION

### Problem to be Solved by the Invention

In the above-described conventional accumulator, the lower limit and upper limit are fixed, so that when the actuators are driven at low pressure, oil at an unnecessarily high charge pressure is stored in the accumulator, the load applied to the hydraulic pump is increased by that amount, and the amount of energy which is consumed becomes large.

The object of the present invention is to solve the problems of the above-described conventional accumulator and to provide a molding machine and a molding method which can reduce the load which is applied to a hydraulic pressure source and reduce energy consumption.

### MEANS FOR SOLVING THE PROBLEM

For this purpose, a molding machine of the present invention has an actuator which is driven by supplied oil, an accumulator which is disposed along an oil passage for supplying oil to the accumulator, a drive pressure sensing section which senses the drive pressure for driving the actuator, a charge pressure sensing section which senses the charge pressure of the accumulator, and a charge pressure setting processing means which sets the charge pressure in accordance with the sensed charge pressure and the sensed drive pressure.

### EFFECTS OF THE INVENTION

According to the present invention, a molding machine has an actuator which is driven by supplied oil, an accumulator which is disposed along an oil passage for supplying oil to the actuator, a drive pressure sensing section which senses the drive pressure for driving the actuator, a charge pressure sensing section which senses the charge pressure of the accumulator, and a charge pressure setting processing means which sets the charge pressure on the basis of the sensed charge pressure and the sensed drive pressure.

In this case, the charge pressure is set on the basis of the sensed charge pressure and the sensed drive pressure, so that oil is not stored in the accumulator at an unnecessarily high charge pressure. Accordingly, the load which is applied to the hydraulic pressure source is reduced by that amount, and energy consumption can be reduced.

### BRIEF DESCRIPTION OF THE DRAWINGS

FIG. 1 is a block diagram showing a control apparatus of a hydraulic circuit in an embodiment of the present invention.

FIG. 2 is a drawing showing the hydraulic circuit in the embodiment of the present invention.

FIG. 3 is a timing chart showing the operation of an accumulator in the embodiment of the present invention.

### DESCRIPTIONS OF REFERENCE NUMERALS

11 Injection cylinder
19 Drive pressure sensor
31 Control section
35 Accumulator
36 Charge pressure sensor
L-3 Oil passage

### BEST MODE FOR CARRYING OUT THE INVENTION

An embodiment of the present invention will now be described in detail while referring to the drawings. In this case, an injection cylinder disposed in an injection apparatus of an injection molding machine will be described as an actuator serving as a drive apparatus. However, the actuator may be a mold-clamping cylinder, an ejector cylinder for advancing and retracting an ejector pin in an ejector apparatus, or a plasticizing moving cylinder used in a plasticizing moving apparatus for advancing and retracting an injection apparatus with respect to a stationary mold. Further, the actuator serving as a drive apparatus may be a hydraulic cylinder or the like used in a mechanical apparatus.

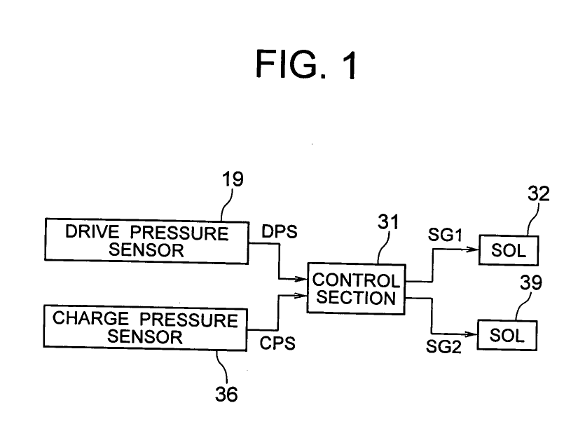

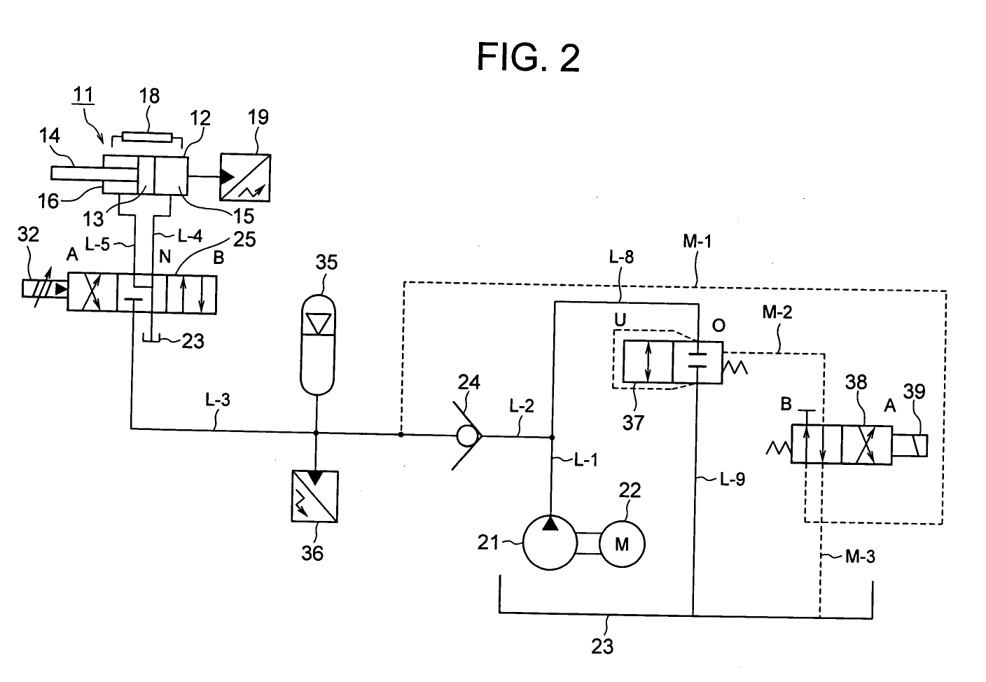

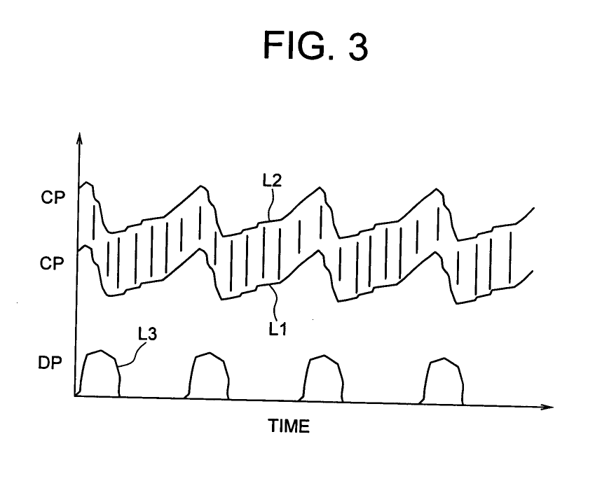

FIG. 1 is a block diagram showing a control apparatus of a hydraulic circuit in an embodiment of the present invention, FIG. 2 is a diagram showing the hydraulic circuit in the embodiment of the present invention, and FIG. 3 is a timing chart showing the operation of an accumulator in the embodiment of the present invention.

In FIG. 2, reference numeral 11 denotes an injection cylinder. In an injection step, by driving this injection cylinder 11, a screw which is disposed in an unillustrated heating cylinder is advanced and retracted, and a resin (molding material) can be injected and suck-back can be carried out. For this purpose, the injection cylinder 11 has a cylinder body 12, a piston 13 which is advanced and retracted (moved leftward and rightward in FIG. 2) within the cylinder body 12, and a piston rod 14 which is formed so as to project forward (leftward in FIG. 2) from the piston 13. The piston rod 14 is linked to the screw. An oil chamber (first chamber) 15 is formed on the piston head side in the cylinder body 12. An oil chamber (second chamber) 16 is formed on the side towards the piston rod 14. By supplying oil to the oil chamber 15 and draining oil from the oil chamber 16, the piston 13 can be advanced (moved to the left in FIG. 2) to advance the screw, and by supplying oil to the oil chamber 16 and draining oil from the oil chamber 15, the piston 13 can be retracted (moved to the right in FIG. 2) to retract the screw.

For the injection cylinder 11, there are provided a position sensor 18 for sensing the position of the piston 13, and a drive pressure sensor (drive pressure sensing section) 19 for sensing the pressure of oil supplied to oil chamber 15; i.e., for sensing the drive pressure DP. A sensed drive pressure DPS signal, which indicates the drive pressure DP which is sensed by the drive pressure sensor 19, is sent to a control section 31. A hydraulic pump 21 is provided as an oil supply source for supplying oil to the injection cylinder 11. In order to operate the hydraulic pump 21, a motor (M) (drive source) 22 is connected to the hydraulic pump 21. When the motor 22 is driven, the hydraulic pump 21 is operated, oil is sucked from an oil tank 23, the oil is discharged into an oil passage L-1, and is supplied to a servo valve 25 through an oil passage L-2, a check valve 24, and an oil passage L-3.

The servo valve 25 assumes a first position A, a second position B, and a third position N. By driving a solenoid (SOL) 32 on the basis of a solenoid signal SG1 from the control section 31, the servo valve is placed in the first through third positions A, B, and N and the flow rate of oil is adjusted. When the servo valve 25 is in the first position A, the oil passage L-3 and an oil passage L-4 are brought into mutual communication, and an oil passage L-5 is brought into communication with the oil tank 23. When the servo valve 25 is in the second position B, the oil passage L-3 and the oil passage L-5 are brought into mutual communication, and the oil passage L-4 is brought into communication with the oil tank 23. When the servo valve 25 is in the third position N, the oil passages L-4 and L-5 are brought into communication with the oil tank 23.

Accordingly, an unillustrated injection processing means of the control section 31 carries out injection processing, and when the solenoid signal SG1 is sent to the solenoid 32, the servo valve 25 is disposed in the first position A, the oil passage L-3 and the oil passage L-4 are brought into mutual communication, and the oil passage L-5 is brought into communication with the oil tank 23. As a result, oil is supplied to the oil chamber 15, oil is drained from the oil chamber 16, the piston 13 is advanced, the screw is advanced, and resin is injected. By changing the value of the solenoid signal SG1, the degree of opening of the servo valve 25 is changed, and the speed of movement of the screw; i.e., the screw speed, can be changed. An unillustrated suck-back processing means of the control section 31 carries out suck-back processing, and when the solenoid signal SG1 is turned off, the servo valve 25 is placed in the second position B, the oil passage L-3 is brought into communication with the oil passage L-5, and the oil passage L-4 is brought into communication with the oil tank 23. As a result, oil is supplied to the oil chamber 16, oil is drained from the oil chamber 15, the piston 13 is retracted, the screw is retracted, and suck-back is carried out.

In order to advance the screw by driving the injection cylinder 11, a large amount of oil must be supplied to the oil chamber 15, and the amount of oil discharged from the hydraulic pump 21 is inadequate. Therefore, an accumulator 35 is disposed along the oil passage L-3, the accumulator 35 is filled with oil at a prescribed charge pressure CP, and when the injection cylinder 11 is driven, oil stored in the accumulator 35 is supplied to the oil chamber 15.

For this purpose, a charge pressure sensor (charge pressure sensing section) 36 for sensing the charge pressure CP is disposed along the oil passage L-3. A sensed charge pressure CPS signal which indicates the charge pressure CP sensed by the charge pressure sensor 36 is sent to the control section 31. A logic valve (filling oil adjusting apparatus) 37 which adjusts the amount of oil stored in the accumulator 35 is connected to an oil passage L-8 which is formed so as to branch from the junction of the oil passages L-1 and L-2. The logic valve 37 assumes an on-load position O and an unload position U. In the on-load position O, the logic valve cuts off communication between the oil passage L-8 and an oil passage L-9, and in the unload position U, the logic valve brings the oil passage L-8 and the oil passage L-9 into communication with the oil tank 23.

An oil passage M-1 branches from the oil passage L-3 between the check valve 24 and the connection between the accumulator 35 and the charge pressure sensor 36. An on-load switching valve (signal oil pressure generating apparatus) 38 is connected to the oil passage M-1. The charge pressure CP is sent to the on-load switching valve 38 as a pilot oil pressure. The on-load switching valve 38 assumes a first position A and a second position B. The valve is placed in the first or second position A or B when a solenoid (SOL) 39 is driven on the basis of a solenoid signal SG2 from the control section 31. The on-load switching valve receives the pilot oil pressure and selectively sends the pilot oil pressure as a signal oil pressure to the logic valve 37 via an oil passage M-2. When the solenoid 39 is in the first position A, the oil passage M-1 and the oil passage M-2 are brought into mutual communication, and when the solenoid 39 is in the second position B, the oil passage M-2 and an oil passage M-3 are brought into communication with the oil tank 23.

Accordingly, unillustrated pressure adjusting processing means of the control section 31 carries out pressure adjustment processing, reads the sensed charge pressure CPS from the charge pressure sensor 36, operates the logic valve 37 on the basis of the sensed charge pressure CPS, and adjusts the charge pressure CP. Therefore, the pressure adjusting processing means determines whether the sensed charge pressure CPS is lower than a previously determined lower limit (first set value) CPL, and when the sensed charge pressure CPS is lower than the lower limit CPL, the pressure adjusting processing means turns the solenoid signal SG2 on and drives the solenoid 39.

As a result, the on-load switching valve 38 is placed in the first position A, the oil passage M-1 and the oil passage M-2 are brought into mutual communication, and a signal oil pressure is supplied to the logic valve 37. The logic valve 37 is located in an on-load position O, and the oil passages L-8 and L-9 are cut off from each other, so that oil which is discharged into the oil passage L-1 is sent through the check valve 24 to the oil passage L-3, and is stored in the accumulator 35. In conjunction with this, the charge pressure CP gradually increases and the sensed charge pressure CPS increases, but the pressure adjusting processing means maintains the solenoid signal SG2 on even when the sensed charge pressure CPS exceeds the lower limit CPL.

Then, the pressure adjusting processing means determines whether the sensed charge pressure CPS is higher than a previously determined upper limit (second set value) CPH. When the sensed charge pressure CPS is higher than the upper limit CPH, the solenoid signal SG2 is turned off, and driving of solenoid 39 is stopped. In this manner, a hysteresis region is established between the lower limit CPL and the upper limit CPH.

As a result, the on-load switching valve 38 is placed in the second position B, the oil passage M-2 and the oil passage M-3 are brought into communication with the oil tank 23, and a signal oil pressure is no longer supplied to the logic valve 37. As a result, the logic valve 37 is placed in the unload position U, and the oil passages L-8 and L-9 are brought into mutual communication, so that oil which is discharged into oil passage L-1 is drained through the oil passage L-8, the logic valve 37, and the oil passage L-9. In conjunction with this, the oil pressure within oil passage L-2 decreases, but the check valve 24 prevents oil within the oil passage L-3 from flowing towards the oil passage L-2, so that the charge pressure CP is maintained constant.

In this manner, the charge pressure CP is adjusted on the basis of the sensed charge pressure CPS and the upper limit CPH and the lower limit CPL, and is maintained at the value of the upper limit CPH. At a prescribed timing, the injection processing means sends the solenoid signal SG1 to the solenoid 32, places the servo valve 25 in the first position A, establishes mutual communication between the oil passage L-3 and the oil passage L-4, and establishes communication between the oil passage L-5 and the oil tank 23. As a result, oil is supplied to the oil chamber 15, oil is drained from the oil chamber 16, the piston 13 is advanced, the screw is advanced, and resin is injected.

At this time, the oil within the accumulator 35 is sent to the oil chamber 15 via the oil passage L-3, the servo valve 25, and the oil passage L-4, and as a result, the charge pressure CP decreases.

If the lower limit CPL and the upper limit CPH are constant, when the injection cylinder 11 is driven at low pressure, oil at an unnecessarily high charge pressure CP is stored in the accumulator 35, the load applied to the oil pressure pump 21 increases by that amount, and energy consumption ends up increasing.

In this embodiment, the lower limit CPL and the upper limit CPH are made variable, and the optimal required pressure is stored in the accumulator 35 as the charge pressure CP.

For this purpose, an unillustrated charge pressure setting processing means of the control section 31 carries out charge pressure setting processing. The charge pressure setting processing means operates the injection molding machine in accordance with previously set molding conditions, performs injection molding a number of times, and during this period, reads the sensed drive pressure DPS and the sensed charging CPS. On the basis of the sensed drive pressure DPS and the sensed charge pressure CPS, the charge pressure setting processing means sets the lower limit CPL and the upper limit CPH.

Therefore, an actual result obtaining processing means of the charge pressure setting pressure processing means carries out actual result obtaining processing, and obtains a maximum sensed drive pressure DPmax indicating the maximum value of the sensed drive pressure DPS and the minimum sensed charge pressure CPmin indicating the minimum value of the sensed charge pressure CPS. Then, the oil pressure determining means of the charge pressure setting processing means carries out oil pressure determination processing, reads the minimum sensed charge pressure CPmin and the maximum sensed drive pressure DPmax, calculates the differential pressure ΔP between the minimum sensed charge pressure CPmin and the maximum sensed drive pressure DPmax as ΔP=CPmin−DPmax, determines whether the differential pressure ΔP is higher than a previously set reference pressure α set for each molded article, and determines the pressure relationship between the charge pressure CP and the drive pressure DP.

When the differential pressure ΔP is higher than the reference pressure α, the charge pressure CP is determined to be unnecessarily high, so that the set pressure changing processing means of the charge pressure setting processing means carries out set pressure changing processing, and sets the upper limit CPH so that the differential pressure ΔP will become equal to the reference pressure α. Then, the set pressure changing processing means calculates and sets the lower limit CPL in consideration of the pressure gradient determined by the discharge ability of the oil pressure pump 21 and the capacity of the accumulator 35 and the molding conditions so that the sensed charge pressure CPS prior to the start of the injection step; i.e., when the servo valve 25 is in the first position A and before oil is supplied to oil chamber 15, is made equal to the upper limit CPH.

In this manner, the upper limit CPH is lowered by just the amount by which the charge pressure CP is unnecessarily high, and at the same time, the lower limit CPL is lowered, so that, as shown in FIG. 3, the charge pressure CP can be changed from the conventional value denoted by line L2 to the value denoted by line L1. In FIG. 3, line L3 denotes the value of the drive pressure DP.

Accordingly, oil at an unnecessarily high charge pressure CP is not stored in the accumulator 35, so that the load applied to the hydraulic pump 21 is lowered by this amount, and energy consumption can be decreased. An oil pressure control apparatus is constituted by the injection cylinder 11, the accumulator 35, the drive pressure sensor 19, the charge pressure sensor 36, the charge pressure setting processing means, and the like.

The upper limit CPH and the lower limit CPL can be set a plurality of times in one molding cycle.

The present invention is not limited to the above-described embodiments. Numerous modifications and variations of the present invention are possible in light of the spirit of the present invention, and they are not excluded from the scope of the present invention.

### INDUSTRIAL APPLICABILITY

It can be applied to a molding machine having a drive apparatus operated by a hydraulic circuit.

1. A molding machine characterized by comprising:
(a) an actuator driven by oil supplied thereto;
(b) an accumulator disposed along an oil passage for supplying oil to the actuator;
(c) a drive pressure sensing section for sensing the drive pressure for driving the actuator;
(d) a charge pressure sensing section for sensing the charge pressure of the accumulator; and
(e) a charge pressure setting processing means which sets the charge pressure on the basis of the charge pressure which is sensed and the drive pressure which is sensed.

2. A molding machine as set forth in claim 1 wherein the charge pressure setting processing means sets the charge pressure on the basis of the minimum sensed charge pressure of the sensed charge pressure and the maximum sensed drive pressure of the sensed drive pressure.

3. A molding machine as set forth in claim 2 wherein the charge pressure setting processing means sets the upper limit of the charge pressure on the basis of the pressure difference between the minimum sensed charge pressure and the maximum sensed drive pressure.

4. A molding machine as set forth in claim 3 wherein the charge pressure setting processing means sets the lower limit of the charge pressure on the basis of the upper limit.

5. A molding machine as set forth in claim 4 including a pressure adjusting processing means which adjusts the charge pressure on the basis of the sensed charge pressure and the upper limit and the lower limit.

6. A molding method characterized by comprising:
(a) sensing a drive pressure for driving an actuator;
(b) sensing the charge pressure of an accumulator disposed along an oil passage for supplying oil to the accumulator; and
(c) setting the charge pressure on the basis of the charge pressure which is sensed and the drive pressure which is sensed.

7. A molding method as set forth in claim 6 including setting the charge pressure on the basis of the minimum sensed charge pressure of the sensed charge pressure and the maximum sensed drive pressure of the sensed drive pressure.

8. A molding method as set forth in claim 7 including setting an upper limit of the charge pressure on the basis of the pressure difference between the minimum sensed charging pressure and the maximum sensed drive pressure.

9. A molding method as set forth in claim 8 including setting the lower limit of the charge pressure on the basis of the upper limit.

10. A molding method as set forth in claim 9 including adjusting the charge pressure on the basis of the sensed charge pressure, the upper limit, and the lower limit.
